(19) United States
(12) Patent Application Publication
(10) Pub. No.: US 2026/0141269 A1
(43) Pub. Date: May 21, 2026

(54) DYNAMICALLY CONSTRUCTING AND MODIFYING AN ALPHA NETWORK OF A RETE NETWORK USED BY A RULE ENGINE

(71) Applicant: Red Hat, Inc., Raleigh, NC (US)

(72) Inventors: Mark Proctor, Farnborough (GB); Luca Molteni, Cernusco Sul Naviglio (IT)

(21) Appl. No.: 18/951,292

(22) Filed: Nov. 18, 2024

(51) Int. Cl. G06N 5/02; G06F 18/22

(52) U.S. Cl. CPC G06N 5/027; G06F 18/22

(57) ABSTRACT

An alpha network of a Rete network used by a rule engine can be dynamically constructed and modified in some examples. As one particular example, a system can dynamically construct an alpha network for a Rete network of a rule engine. The alpha network is dynamically constructed in memory during an execution time of the rule engine. The alpha network is dynamically constructed based on data objects propagating through alpha nodes of the alpha network. The alpha nodes correspond to constraints defined in a predefined set of rules for the rule engine. After dynamically constructing the alpha network, the system can propagate a data object through the alpha network to a beta network of the Rete network.

### TECHNICAL FIELD

The present disclosure relates generally to execution of a Rete network used by a rule engine on a computer. More specifically, but not by way of limitation, this disclosure relates to reducing processor and memory usage by dynamically constructing and modifying an alpha network of a Rete network used by a rule engine.

### BACKGROUND

A rule engine is software that can process information by applying rules to data objects (also known as “facts”). A rule is a logical construct for describing operations, definitions, conditions, and/or constraints that apply to a data object. To process rules and data objects, a rule engine can implement a network. The network includes a tree of interconnected nodes. There are many different types of nodes, such as object-type nodes, alpha nodes, left-input-adapter nodes, eval nodes, join nodes, and terminal nodes.

One type of network often used in rule engines is a Rete network. A Rete network uses a rooted acyclic direct graph where the nodes, with the exception of the root node, represent conditions. Paths from the root node to the leaf nodes can represent left-hand sides of rules. Each node can hold a list of data objects that satisfy an associated condition. A Rete algorithm keeps the information associated with the nodes current. When a data object is added to working memory, a token representing the data object is entered at the root of the Rete network and propagated to its leaves, modifying as appropriate the information associated with the nodes.

The first part of a Rete network is an alpha network, which is a type of discrimination tree. The alpha network can include one or more branches of alpha nodes, where the alpha nodes have parent-child relationships to one another. The alpha network is responsible for selecting data objects by comparing attributes of the data objects against the conditions represented by the alpha nodes. If a data object is successfully matched against a condition represented by an alpha node in a branch, the data object is passed to the next alpha node in the branch. Each branch of alpha nodes can terminate at a memory, called an alpha memory. The alpha memory can store a collection of data objects that match each condition in each alpha node of the corresponding node branch. The collection of data objects in each alpha memory may then be propagated to a rule terminal node, which can interact with an “agenda” of the rule engine to list all of the rules that should be executed, along with the collection of responsible data objects.

### BRIEF DESCRIPTION OF THE DRAWINGS

FIG. 1 shows a block diagram of an example of a system for dynamically constructing and modifying an alpha network of a Rete network used by a rule engine according to some aspects of the present disclosure.

FIG. 2 shows an example of pruning an alpha node of an alpha network according to some aspects of the present disclosure.

FIG. 3 shows an example of joining a static alpha network to a dynamic alpha network according to some aspects of the present disclosure.

FIG. 4 shows a block diagram of an example of a system for dynamically constructing and modifying an alpha network of a Rete network used by a rule engine according to some aspects of the present disclosure.

FIG. 5 shows a flowchart of an example of a process for dynamically constructing and modifying an alpha network of a Rete network used by a rule engine according to some aspects of the present disclosure.

### DETAILED DESCRIPTION

A rule engine may include a Rete network that is defined by rules (e.g., business rules) input by a user. The rule engine can then evaluate the rules against data objects, for example by propagating each data object through an alpha network of the Rete network.

A rule engine can operate in two modes: network build time and execution time. Build time is when the Rete network is built. Execution time is when data objects propagate through the Rete network and rule firing occurs. Normally, the alpha network is created during network build time and remains static (fixed) throughout execution time. Thus, such an alpha network is referred to herein as a static alpha network. During its execution time, the rule engine can evaluate each alpha node of the static alpha network against each data object. This can be computationally slow and use a significant amount of processing power. Additionally, because the alpha network remains fixed throughout the execution time, even if some of the alpha nodes are rarely or never used, they remain in the alpha network anyway, which can further waste computing resources.

Some examples of the present disclosure can overcome one or more of the abovementioned problems by dynamically constructing an alpha network of a Rete network during the rule engine’s execution time, based on which alpha nodes are activated by data objects to be transmitted through the alpha network. Such an alpha network can be referred to as a dynamic alpha network. The alpha network’s size can also be dynamically adjusted over time by adding and removing alpha nodes when certain criteria are met. Dynamically creating and adjusting the alpha network over time can avoid unnecessary computations, memory consumption, and processing usage due to unused or rarely used alpha nodes.

More specifically, some examples can dynamically build an alpha network of a Rete network on-demand using only the needed subparts of the overall network. A queue-based eviction policy (e.g., based on length and time) can be used to prune the alpha network, allowing it to grow and shrink as needed over time. For example, an alpha node may be pruned from the alpha network if it is unused for a predefined length of time. Pruning the alpha network can reduce processing consumption as compared to a static alpha network, particularly if the rule set is very large (e.g., it contains hundreds or thousands of rules).

In some examples, the alpha network is built dynamically during execution time based on propagated data objects. Each rule engine instance can create its own local instance of the alpha network, which can be dynamically adjusted over time by the rule engine instance. Such alpha networks are referred to herein as a dynamic local alpha networks. Immutable data for the alpha nodes can be shared among the dynamical local alpha networks. A flyweight pattern can be used to cache the immutable data for sharing purposes.

In some examples, a user can choose between using a static alpha network or a dynamical alpha network with the rule engine. This may be an option that is selectable by the user. The static alpha network may be a global alpha network, in the sense that it can be concurrently used by multiple instances of the rule engine and does not change. Based on the user selection, either the static global alpha network or a dynamic local alpha network can be used by the rule engine. A static alpha network may be beneficial for short-lived executions with small amounts of data, which are unlikely to benefit from the cost of building the alpha network on-demand as it would be a significant amount of the overall execution time. In contrast, a dynamic alpha network may be worthwhile with longer-lived executions, since the build process would be an insignificant fraction of the overall execution time.

In some examples, a user can choose to combine a static alpha network and a dynamical alpha network. This may be an option that is selectable by the user. Based on the user selection, the rule engine can load a first alpha network into memory during network build time, where the first alpha network is a static alpha network. Then, the rule engine can construct a second alpha network during execution time, where the second alpha network is a dynamic alpha network. The rule engine can connect the first alpha network to the second alpha network at a junction node, to produce an overall alpha network in which some parts are static and others are dynamic. This may allow for increasing flexibility in how the alpha network functions.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

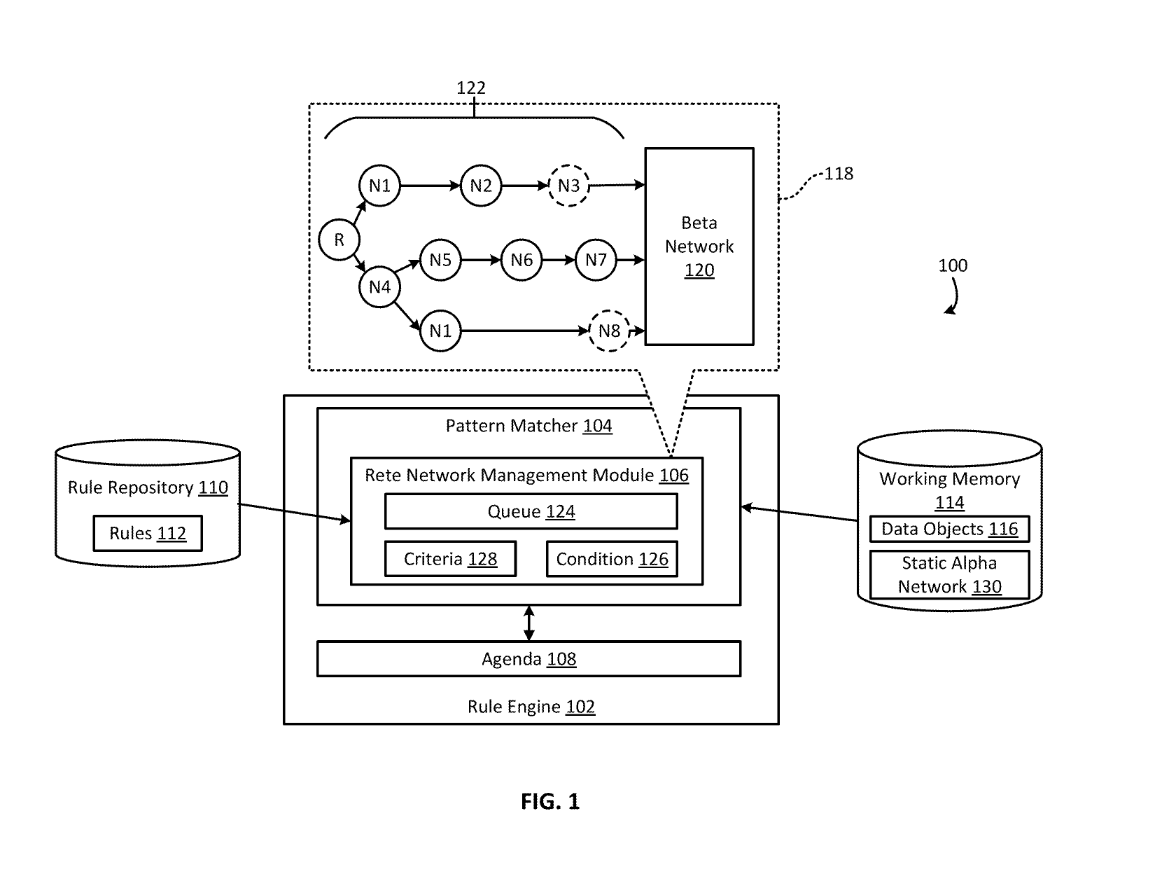

FIG. 1 shows a block diagram of an example of a system 100 for dynamically constructing and modifying an alpha network 122 of a Rete network 118 used by a rule engine 102 according to some aspects of the present disclosure. The system 100 includes the rule engine 102, a working memory 114, and a rule repository 110. The rule repository 110 can include a predefined set of rules 112 usable to evaluate data objects (or “facts”). The rule repository 110 can be any suitable type of data structure, such as a database of rules, a table of rules, etc. Each rule can have a lefthand side and a righthand side. The lefthand side can correspond to one or more constraints of the rule. The righthand side can correspond to one or more actions to be performed if the one or more constraints of the rule are satisfied. The working memory 114 can store data objects 116 that are to be matched against the rules 112. The data objects 116 can be added to the working memory 114 and removed from the working memory 114 by the rule engine 102, which is software executable on a computer.

The rule engine 102 can include a pattern matcher 104. The pattern matcher 104 can generate a Rete network 118 based on the rules 112 stored in the rule repository 110. The Rete network 118 can be created by linking together nodes. A majority of the nodes can correspond to conditions expressed in the rules 112. If multiple rules 112 have the same condition, a single node may be shared by the multiple rules 112.

Once created, the Rete network 118 can be used to evaluate the rules 112 from the rule repository 110 against the data objects 116 in the working memory 114. As the data objects 116 propagate through the Rete network 118, the pattern matcher 104 can evaluate the data objects 116 against the rules 112 (e.g., the constraints derived from the rules 112). Fully matched rules can result in activations, which are stored in the agenda 108. The agenda 108 can include a list of activations. Each activation can be a rule to be executed and a data object on which to execute the rule. The rule engine 102 can execute (or “fire”) the activations in any suitable order. For example, the rule engine 102 iterate through the agenda 108 to fire the activations sequentially or can fire the activations randomly.

In a conventional scenario, the pattern matcher 104 generates or loads a static alpha network 130 during a network build time of the rule engine 102, which is prior to the execution time of the rule engine 102. The static alpha network 130 then remains the same throughout the execution time of the rule engine 102, regardless of whether the alpha nodes in the static alpha network 130 are used or not. This can lead to wasted memory and computing resources (e.g., processing power and memory).

To overcome the abovementioned problems, some examples can include a Rete Network Management Module (RNMM) 106, which is a software component that can dynamically construct an alpha network 122 during the execution time, rather than during network build time. The RNMM 106 can dynamically construct the alpha network 122 during execution time by adding nodes to the alpha network 122 based on the rules 112 and data objects 116 that propagate through the alpha network 122 during execution time. For example, the RNMM 106 can identify the first data object 116 to be passed through the alpha network 122, determine a rule 112 satisfied by the first data object 116, and add an alpha node corresponding to the rule 112 to the alpha network 122. This process can repeat for additional data objects 116, so that the alpha network 122 is dynamically built out based on which rules are actually getting activated by the data objects 116 in real time. This iterative process can produce an alpha network 122 with any number of branches and any number of nodes-per-branch. Over time, fewer and fewer alpha nodes will be added to the alpha network 122 with each iteration, eventually reaching a relatively steady state condition. At that point, the dynamically constructed alpha network 122 can include alpha nodes that represent the most commonly used rules, and may also have alpha nodes that represent less commonly used rules that have nevertheless been activated by the data objects 116. Using this process, the overall size of the alpha network 122 can depend on which rules 112 are actually activated by the data objects 116, and will thus be smaller in size than a static alpha network 130 that contains all of the rules 112.

After the dynamic alpha network 122 is created, the RNMM 106 can adjust its size in response to detecting various events. For example, the RNMM 106 may add one or more alpha nodes to the alpha network 122 in response to detecting that a particular rule 112 is activated by a new data object 116. Additionally, the RNMM 106 can prune (remove) one or more existing alpha nodes from the alpha network 122 in response to detecting an event. For example, the RNMM 106 can prune Nodes N3 and N8 from the alpha network 122 in response to detecting that they have not been activated for at least a predefined length of time. In some examples, the user can select or customize the events that result in pruning. Removing unused or rarely used nodes from the alpha network 122 can decrease its size, thereby reducing consumption of computing resources. This also reduces the number of joins in the beta network 120, which further reduces consumption of computing resources.

In some examples, the RNMM 106 can determine that an alpha node (e.g., N8) is a candidate for pruning from the alpha network 122 based on the alpha node satisfying a predefined criterion 128. An example of the predefined criterion 128 may be that the alpha node has not been activated for at least a predefined length of time, such as one hour. Based on determining that the alpha node is a candidate for pruning, the RNMM 106 can add the alpha node to a pruning queue 124. After adding the alpha node to the pruning queue 124, the RNMM 106 can determine whether a condition 126 is satisfied with respect to the pruning queue 124. One example of the condition 126 may be that the pruning queue 124 is full. Based on determining that the condition 126 is satisfied, the RNMM 106 can prune the alpha node from the alpha network 122. This may involve deleting the data associated with the alpha node from memory (e.g., working memory 114).

Alpha nodes can be pruned from the alpha network 122 from the end to the beginning – e.g., moving from the leaf nodes toward the root node (R). The leaf nodes are the nodes that are closest to the beta network 120. For example, the leaf nodes in FIG. 1 are Nodes 3, 7, and 8. Those nodes can be evaluated for pruning first, before Nodes N2, N6, and N1 are evaluated. As leaf nodes are evaluated and pruned, their parent nodes may themselves become leaf nodes that are eligible for pruning, and so on. Thus, the alpha nodes in a given branch of the alpha network 122 can be evaluated in their sequence. However, the root node is never evaluated or pruned.

In some examples, a single alpha node may be shared between multiple branches of the alpha network 122. For instance, a particular rule represented by the alpha node may be shared among multiple rules in the set of rules 112. Such alpha nodes are referred to herein as shared alpha nodes. One example of a shared alpha node can be Node N4. The RNMM 106 can identify the shared alpha nodes and flag them as ineligible for pruning. That way, the shared alpha nodes are not pruned from the alpha network 122, which could otherwise lead to errors.

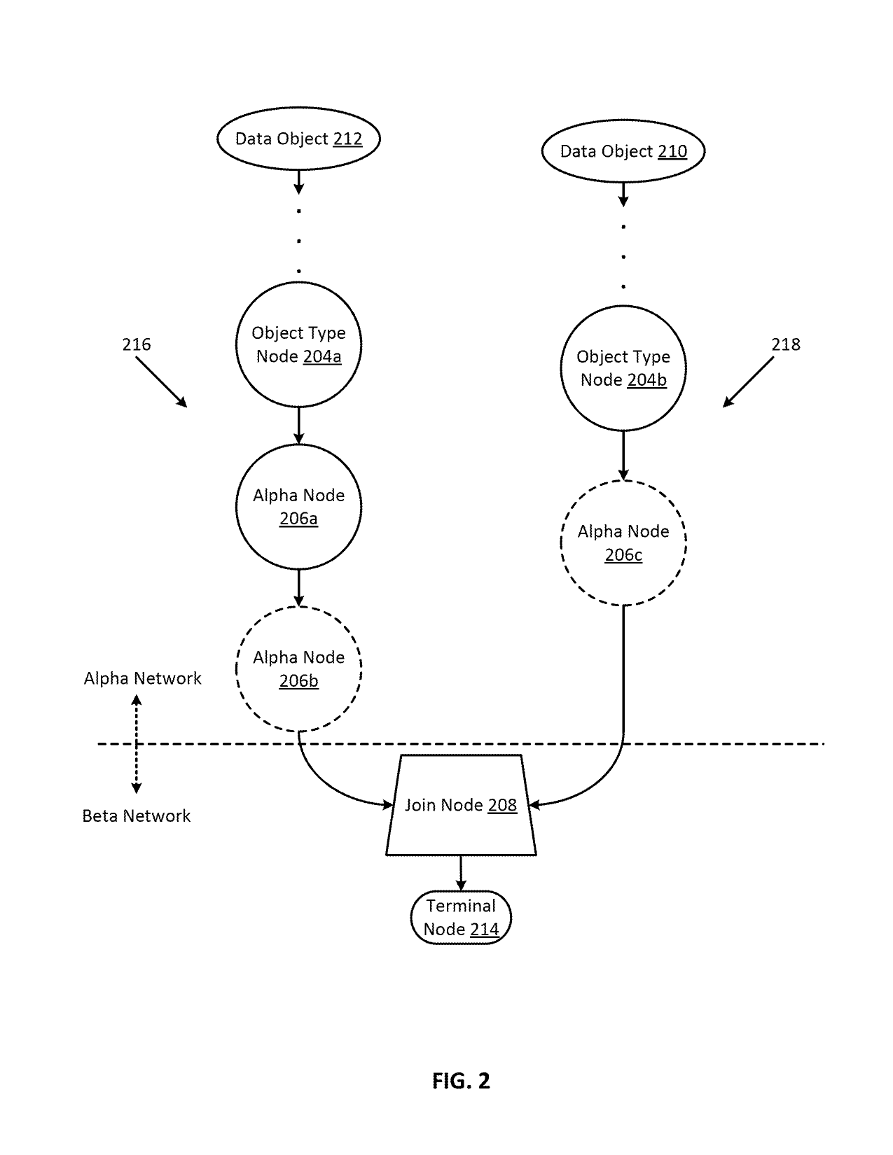

Turning now to FIG. 2, shown is an example of pruning an alpha node of an alpha network according to some aspects of the present disclosure. In this example, the alpha network can include object type nodes 204a-b and alpha nodes 206a-c. The alpha nodes 206b-c can form two branches 216-218 of the alpha network and connect at a join node 208, which can be part of a beta network. The combination of the alpha network and the beta network can form at least part of the Rete network. Data objects 210-212 can propagate down both branches of the alpha network to the join node 208, where they can be evaluated. If either or both of the data objects 210-212 satisfy the conditions of the join node 208, they can be passed on to the terminal node 214.

In some examples, an alpha node 206b can be pruned from the alpha network based on the alpha node 206b satisfying one or more predefined criteria. Examples of the predefined criteria may include the alpha node 206b being of a certain type, corresponding to a certain rule, or not having been activated for at least a threshold period of time. If the alpha node 206b satisfies the one or more predefined criteria, it may be added to a pruning queue and eventually pruned from the alpha network. After alpha node 206b is pruned, the alpha node 206a would become the last alpha node in the branch 216 prior to the beta network (e.g., the join node 208).

In some examples, the RNMM 106 can determine whether the working memory 114 includes at least one data object 116 that satisfies a left-hand side of a condition corresponding to a particular alpha node 206b of the alpha network. The particular alpha node 206b can be joined to another alpha node 206c at a later node (e.g., join node 208) of the Rete network. If the working memory 114 does not include at least one data object 116 that satisfies the left-hand side of the condition, the RNMM 106 can flag the other alpha node 206c as a candidate for pruning. This is because if the left-hand side condition of the particular alpha node 206b is not satisfied by any of the data objects 116, nothing will ever be joined at the join node 208, so the other alpha node 206c becomes unnecessary. The RNMM 106 may then eventually prune the other alpha node 206c from the alpha network.

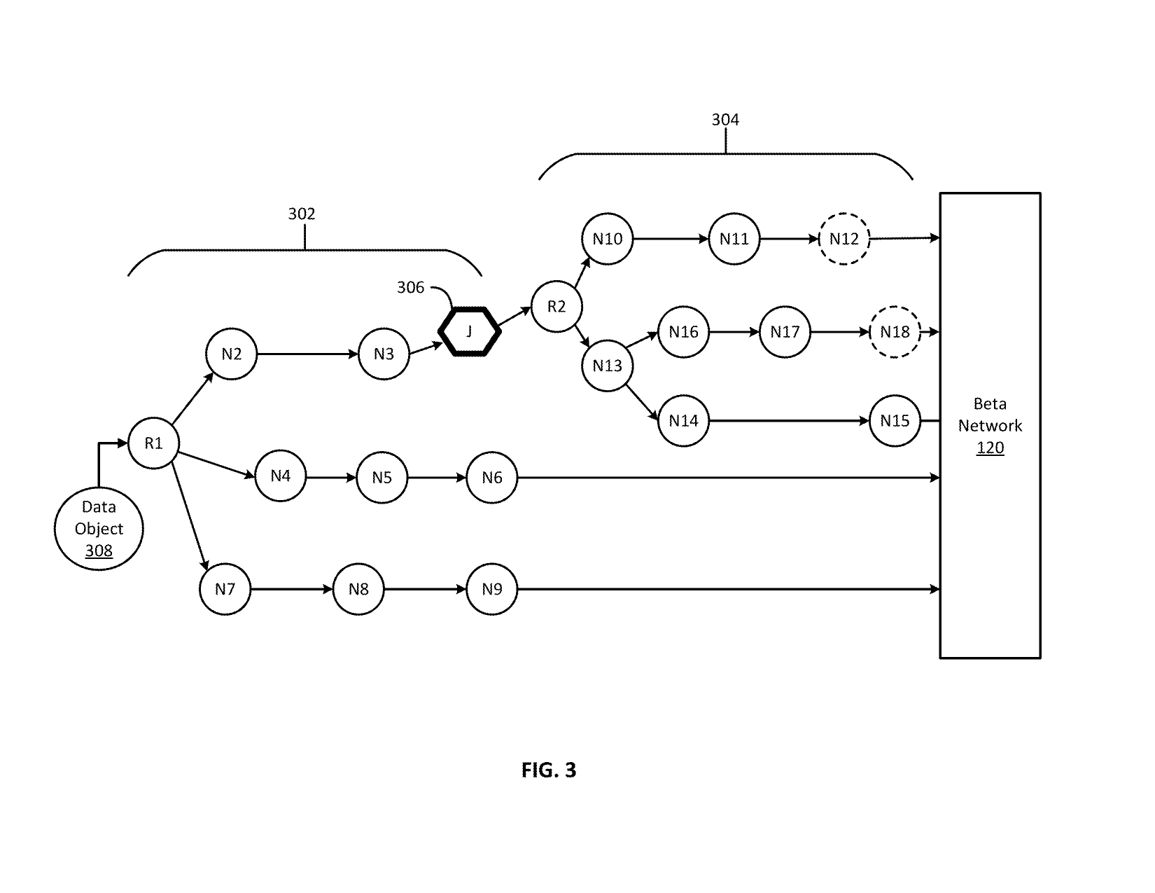

Turning now to FIG. 3, shown is an example of joining a static alpha network 302 to a dynamic alpha network 304 according to some aspects of the present disclosure. More specifically, as previously described, the RNMM 106 can dynamically generate an alpha network 304 during the execution time of the rule engine. But in some cases, a user may wish to have a static alpha network 302 combined with the dynamic alpha network 304 for various reasons. To that end, the RNMM 106 may generate or load a static alpha network 302 into working memory during a network build time of the rule engine. Thereafter, the RNMM 106 can construct the dynamic alpha network 304 using the process described above during execution time. The dynamic alpha network 304 can be linked to the static alpha network 302 by a junction node 306. Thus, only data objects 308 that propagate down the correct branch of the static alpha network 302 to reach the junction node 306 will ultimately pass through the dynamic alpha network 304.

Once the dynamic alpha network 304 is linked to the static alpha network 302, a data object 308 can propagate through the static alpha network 302 to eventually reach the junction node 306, and then propagate from the junction node 306 through the dynamic alpha network 304. If the dynamic alpha network 304 is still in the process of being constructed, in some examples the data object 308 may be held (e.g., paused) at the junction node 306 until the dynamic alpha network 304 is ready to receive the data object 308.

Because the dynamic alpha network 304 is dynamic, it can be modified while connected to the static alpha network 302. For instance, Nodes 12 and 18 may be pruned over time from the dynamic alpha network 304, as represented by their dashed outlines, while the dynamic alpha network 304 is connected to the static alpha network 302 via the junction node 306.

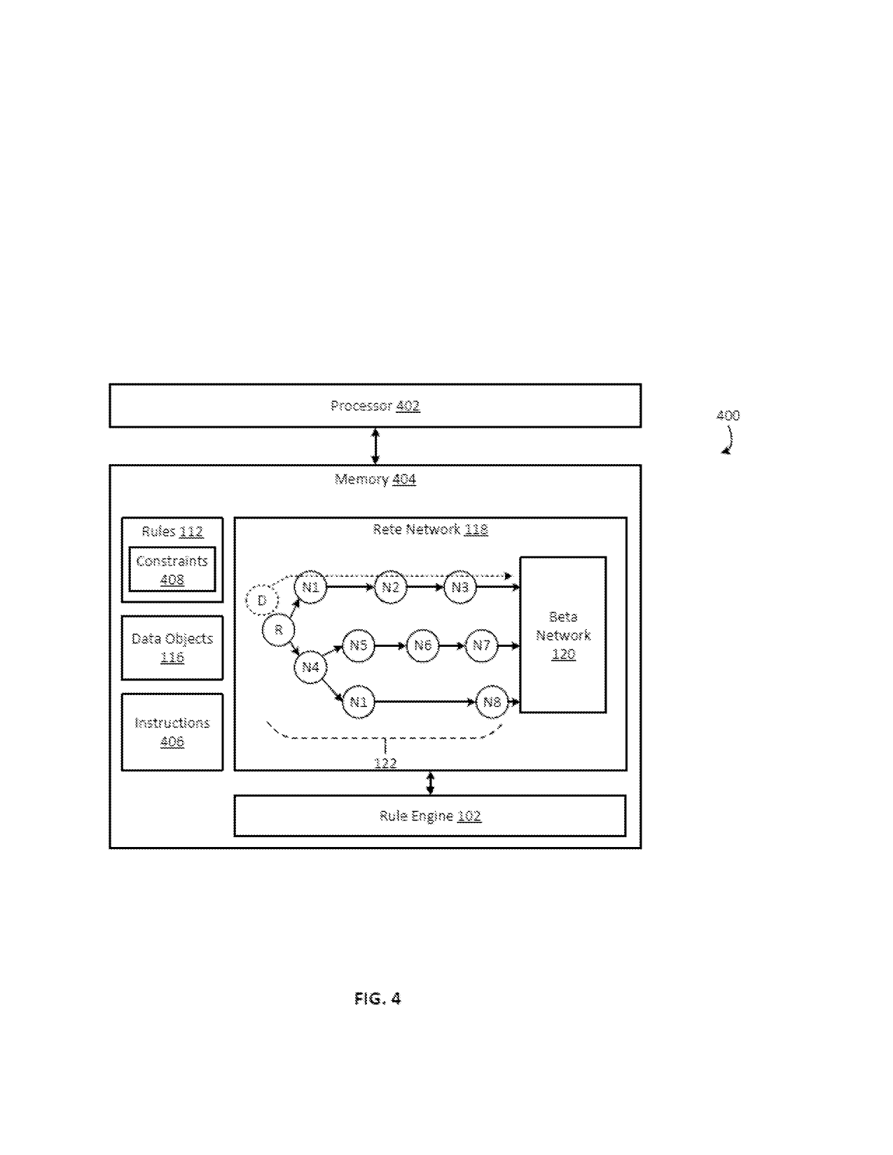

Turning now to FIG. 4, shown is a block diagram of an example of a system 400 for dynamically constructing and modifying an alpha network 122 of a Rete network 118 used by a rule engine 102 according to some aspects of the present disclosure. The system 400 includes a processor 402 communicatively coupled to a memory 404 by a bus. The processor 402 can include one processing device or multiple processing devices. Non-limiting examples of the processor 402 include a Field-Programmable Gate Array (FPGA), an application-specific integrated circuit (ASIC), a microprocessor, or any combination of these. The processor 402 can execute instructions 406 stored in the memory 404 to perform operations, such as any of the operations described above with respect to the RNMM 106. In some examples, the instructions 406 can include processor-specific instructions generated by a compiler or an interpreter from code written in any suitable computer-programming language, such as C, C++, C#, Python, or Java.

The memory 404 can include one memory device or multiple memory devices. The memory 404 can be volatile or non-volatile, such that the memory 404 retains stored information when powered off. Non-limiting examples of the memory 404 include electrically erasable and programmable read-only memory (EEPROM), flash memory, or any other type of non-volatile memory. At least some of the memory device can include a non-transitory computer-readable medium from which the processor 402 can read the instructions 406. A computer-readable medium can include electronic, optical, magnetic, or other storage devices capable of providing the processor 402 with computer-readable instructions or other program code. Non-limiting examples of a computer-readable medium can include magnetic disks, memory chips, ROM, random-access memory (RAM), an ASIC, a configured processor, optical storage, or any other medium from which a computer processor can read the instructions 406.

The processor 402 can execute the instructions 406 to perform operations. For example, the processor 402 can dynamically construct an alpha network 122 for a Rete network 118 of a rule engine 102. The alpha network 122 is dynamically constructed in memory (e.g., working memory 114) during the execution time of the rule engine 102. The alpha network 122 is dynamically constructed based on data objects 116 propagating through alpha nodes of the alpha network 122. The alpha nodes can correspond to constraints 408 defined in a predefined set of rules 112 for the rule engine 102. After dynamically constructing the alpha network 122, the processor 402 can propagate a data object 116 through the alpha network 122 to a beta network 120 of the Rete network 118. This is represented in FIG. 4 by the data object (D) propagating through Nodes 1-3, as shown by a dashed arrow.

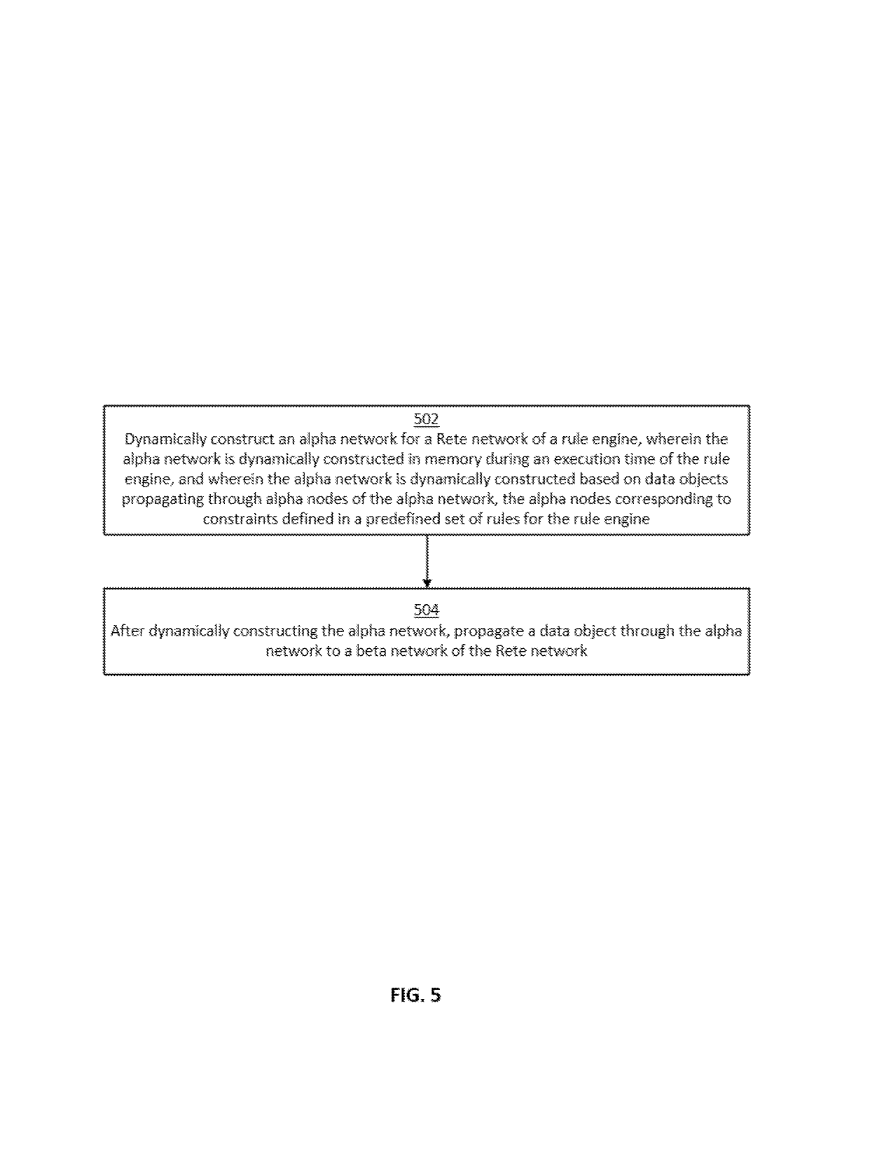

FIG. 5 shows a flowchart of an example of a process for dynamically constructing and modifying an alpha network of a Rete network used by a rule engine according to some aspects of the present disclosure. Other examples may involve more operations, fewer operations, different operations, or a different sequence of operations than is shown in FIG. 5. The operations of FIG. 5 are described below with reference to the components of FIG. 4 described above.

In block 502, a processor 402 dynamically constructs an alpha network 122 for a Rete network 118 of a rule engine 102. The alpha network 122 is dynamically constructed in memory (e.g., working memory 114) during an execution time of the rule engine 102. The alpha network 122 is dynamically constructed based on data objects 116 propagating through alpha nodes of the alpha network 122. The alpha nodes can correspond to constraints 408 defined in a predefined set of rules 112 for the rule engine 102.

In block 504, the processor 402 propagates a data object 116 through the alpha network 122 to a beta network 120 of the Rete network 118, after dynamically constructing the alpha network 122. The data object 116 may then continue through the beta network 120 and may eventually reach a terminal node of the Rete network 118.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A non-transitory computer-readable medium comprising program code that is executable by one or more processors for causing the one or more processors to perform operations including:
dynamically constructing an alpha network for a Rete network of a rule engine, wherein the alpha network is dynamically constructed in memory during an execution time of the rule engine, and wherein the alpha network is dynamically constructed based on data objects propagating through alpha nodes of the alpha network, the alpha nodes corresponding to constraints defined in a predefined set of rules for the rule engine; and
after dynamically constructing the alpha network, propagating a data object through the alpha network to a beta network of the Rete network.

2. The non-transitory computer-readable medium of claim 1, wherein the operations further comprise, after dynamically constructing the alpha network:
determining that an alpha node of the alpha network is to be pruned from the alpha network; and
removing the alpha node from the alpha network to thereby produce an updated alpha network for the rule engine.

3. The non-transitory computer-readable medium of claim 2, wherein the operations further comprise:
determining that the alpha node is a candidate for pruning from the alpha network based on the alpha node satisfying a predefined criterion;
based on determining that the alpha node is a candidate for pruning, adding the alpha node to a pruning queue;
after adding the alpha node to the pruning queue, determining that a condition is satisfied with respect to the pruning queue; and
based on determining that the condition is satisfied, pruning the alpha node from the alpha network.

4. The non-transitory computer-readable medium of claim 2, wherein the operations further comprise:
determining whether the memory includes at least one data object that satisfies a left-hand side of a condition corresponding to a particular alpha node of the alpha network, the particular alpha node being different from the alpha node, wherein the particular alpha node and the alpha node are joined together at a later node of the Rete network; and
based on determining that the memory does not include at least one data object that satisfies the left-hand side of the condition, flagging the alpha node as a candidate for pruning.

5. The non-transitory computer-readable medium of claim 1, wherein the operations further comprise:
determining that an alpha node is shared among multiple rules in the predefined set of rules;
based on determining that the alpha node is shared among the multiple rules, flagging the alpha node as ineligible for pruning from the alpha network; and
based on the flagging, preventing the alpha node from being pruned from the alpha network.

6. The non-transitory computer-readable medium of claim 1, wherein the operations further comprise, after dynamically constructing the alpha network:
sequentially pruning alpha nodes from the alpha network, starting from leaf nodes of the alpha network and working towards a root node of the alpha network, wherein the leaf nodes are positioned closest to the beta network of the Rete network.

7. The non-transitory computer-readable medium of claim 1, wherein the alpha network is a dynamic alpha network, and wherein the operations further comprise:
loading a static alpha network into the memory, the static alpha network being different from the dynamic alpha network, wherein the static alpha network was loaded during a network build time of the rule engine;
joining a particular alpha node of the static alpha network to another alpha node of the dynamic alpha network by a junction node; and
propagating the data object through the static alpha network to the junction node, and then from the junction node through the dynamic alpha network.

8. The non-transitory computer-readable medium of claim 7, wherein the operations further comprise:
modifying the dynamic alpha network while the dynamic alpha network is connected to the static alpha network at the junction node.

9. The non-transitory computer-readable medium of claim 1, wherein the operations further comprise:
after dynamically constructing the alpha network, modifying the alpha network in response to detecting an event, wherein modifying the alpha network involves adding a new alpha node to the alpha network or removing an existing alpha node from the alpha network.

10. A computer-implemented method, comprising:
dynamically constructing an alpha network for a Rete network of a rule engine, wherein the alpha network is dynamically constructed in memory during an execution time of the rule engine, and wherein the alpha network is dynamically constructed based on data objects propagating through alpha nodes of the alpha network, the alpha nodes corresponding to constraints defined in a predefined set of rules for the rule engine; and
after dynamically constructing the alpha network, propagating a data object through the alpha network to a beta network of the Rete network.

11. The method of claim 10, further comprising, after dynamically constructing the alpha network:
determining that an alpha node of the alpha network is to be pruned from the alpha network; and
removing the alpha node from the alpha network to thereby produce an updated alpha network for the rule engine.

12. The method of claim 11, further comprising:
determining that the alpha node is a candidate for pruning from the alpha network based on the alpha node satisfying a predefined criterion;
based on determining that the alpha node is a candidate for pruning, adding the alpha node to a pruning queue;
after adding the alpha node to the pruning queue, determining that a condition is satisfied with respect to the pruning queue; and
based on determining that the condition is satisfied, pruning the alpha node from the alpha network.

13. The method of claim 11, further comprising:
determining whether the memory includes at least one data object that satisfies a left-hand side of a condition corresponding to a particular alpha node of the alpha network, the particular alpha node being different from the alpha node, wherein the particular alpha node and the alpha node are joined together at a later node of the Rete network; and
based on determining that the memory does not include at least one data object that satisfies the left-hand side of the condition, flagging the alpha node as a candidate for pruning.

14. The method of claim 10, further comprising:
determining that an alpha node is shared among multiple rules in the predefined set of rules; and
based on determining that the alpha node is shared among the multiple rules, flagging the alpha node as ineligible for pruning from the alpha network.

15. The method of claim 10, further comprising, after dynamically constructing the alpha network:
sequentially pruning alpha nodes from the alpha network, starting from leaf nodes of the alpha network and working towards a root node of the alpha network, wherein the leaf nodes are positioned closest to the beta network of the Rete network.

16. The method of claim 10, wherein the alpha network is a dynamic alpha network, and further comprising:
loading a static alpha network into the memory, the static alpha network being different from the dynamic alpha network, wherein the static alpha network was loaded during a network build time of the rule engine;
joining a particular alpha node of the static alpha network to another alpha node of the dynamic alpha network by a junction node; and
propagating the data object through the static alpha network to the junction node, and then from the junction node through the dynamic alpha network.

17. The method of claim 16, further comprising:
modifying the dynamic alpha network while the dynamic alpha network is connected to the static alpha network at the junction node.

18. The method of claim 10, further comprising:
after dynamically constructing the alpha network, modifying the alpha network in response to detecting an event, wherein modifying the alpha network involves adding a new alpha node to the alpha network or removing an existing alpha node from the alpha network.

19. A system comprising:
one or more processors; and
one or more memories storing instructions that are executable by the one or more processors for causing the one or more processors to perform operations including:
dynamically constructing an alpha network for a Rete network of a rule engine, wherein the alpha network is dynamically constructed in memory during an execution time of the rule engine, and wherein the alpha network is dynamically constructed based on data objects propagating through alpha nodes of the alpha network, the alpha nodes corresponding to constraints defined in a predefined set of rules for the rule engine; and
after dynamically constructing the alpha network, propagating a data object through the alpha network to a beta network of the Rete network.

20. The system of claim 19, wherein the operations further comprise:
after dynamically constructing the alpha network, modifying the alpha network in response to detecting an event, wherein modifying the alpha network involves adding a new alpha node to the alpha network or removing an existing alpha node from the alpha network.
